(19) United States
(12) Patent Application Publication
(10) Pub. No.: US 2023/0233284 A1
(43) Pub. Date: Jul. 27, 2023

(54) Four in one dental extraction kit

(71) Applicant: Boris Kaylakov, Rego Park, NY (US)

(72) Inventor: Boris Kaylakov, Rego Park, NY (US)

(21) Appl. No.: 17/585,258

(22) Filed: Jan. 26, 2022

(51) Int. Cl. A61C 3/14

(52) U.S. Cl. CPC A61C 3/14

(57) ABSTRACT

The present invention relates to a novel combination device for tooth extraction with Snap-On handle and interchangeable or retractable working ends. More specifically, a four in one device for increasing movement of a tooth in the jaw. The invention is designed to create space between bone and root; elevate roots for easy extraction. The invention is a four in one interchangeable dental elevator extraction kit. The device provides a new and improved method of increasing movement and extraction of a tooth in a jaw. The novel dental tooth extraction device is composed of a single handle, single hollow metal cylinder with two double ended bits. One double ended bit contains two different straight elevators on opposite sides. The Second double ended bit contains two root tip picks on opposite ends. Each double bit is designed with a different tip.

### FIELD OF INVENTION

The present invention relates to a novel combination device for tooth extraction with Snap-On handle and interchangeable or retractable working ends. More specifically, a four in one device for increasing movement of a tooth in the jaw. The invention is designed to create space between bone and root; elevate roots for easy extraction.

### BACKGROUND

Extraction is the optimal treatment option when treating tooth that is non-restorable or impossible to save with predictable results due to depth of decay, severe bone loss, fracture below gum or extensive and significant infection. In other words, removal of tooth is mandatory for several reasons including deep subgingival or crestal decay, gross decay, roots, infections, tooth fractures, severe periodontal disease, dental abscesses, mobile or loose teeth and many more.

Traditional dental extraction elevators usually take substantial space on a bracket table during dental tooth extraction procedures. Due to that factor, dental provider usually lacks the sufficient area for other necessary equipment. Sometimes dental assistant needs to bring different devices during a procedure, creating delays and exposure to contamination during dental extraction. Also, dental cabinets usually labeled to make easier instrument retrieval. Also, when multiple instruments are used for the same procedure more dental cabinets are needed and that creates space restriction. Another challenge for traditional dental extraction; sterilization must be working constantly to sterilize multitude of instruments. Since these bulky instruments take up so much space a need to get duplicate of same device makes it nearly impossible unless office space is increased. Thus, sterilization is working double due to those drawbacks.

The present invention solves those problems. The novel devices are designed to improve dental extraction procedure and make it quicker. The tools are interchangeable therefore reduced movement. No unnecessary movement to find other instrument or change instrument while operating on a patient, That in turn will improve dental practitioner's concentration and therefore the result or outcome of treatment for a patient.

### BRIEF SUMMARY OF INVENTION

The present disclosure is to be considered as an exemplification of the invention and is not intended to limit the invention to the specific embodiments illustrated by figures or description below. The invention is a four in one interchangeable dental elevator extraction kit. The device provides a new and improved method of increasing movement and extraction of a tooth in a jaw. The novel dental tooth extraction device is composed of a single handle, single hollow metal cylinder with two double ended bits. One double ended bit contains two different straight elevators on opposite sides. The Second double ended bit contains two root tip picks on opposite ends. Each double bit is designed with a different tip. The invention comprises of two double end, four elevator tips. A 301 Apexo Elevator (2.5 mm tip or working end), 343 straight elevator (4 mm), #63 spade elevator on one end and #1 Heidbrink straight root tip on the other end.

Thus, one device with two interchangeable double ended bits will replace four separate tooth extraction elevators. That will make the process of dental extraction quicker; because there is no need to find other instrument just flip and insert or interchange bits,

The invention is easy to assemble and disassemble. To assemble simply, insert a bit on each side of the hollow metal cylinder and plug into the handle and to disassemble simply reverse the process. One shaft end is designed to contain two different elevator tips. The double tip bit can be flipped over for use; thereby creating a one device connecting four dental tools seamlessly. This method saves time, improves practitioner concentration, eliminates lengthy hours of sterilization and need for spacious cabinets to maintain all instruments. The invention is lightweight and compact.

### BRIEF DESCRIPTION OF THE DRAWINGS

FIG. 1 is a perspective view of one embodiment of the four in one interchangeable dental tool kit as it would appear disassembled,

FIG. 2 is an exploded perspective view of the component parts of the present invention and how it will fit.

FIG. 3. is a close-up view of one embodiment of the invention.

FIG. 4. is a perspective view of one embodiment of the invention.

FIG. 5. is a perspective view of one embodiment of the invention.

FIG. 6. is a perspective view of one embodiment of the invention.

FIG. 7. is a perspective view of one embodiment of the invention.

FIG. 8. is a perspective view of one embodiment of the four in one interchangeable dental tool kit as it would appear assemble.

### DETAILED DESCRIPTION OF THE DRAWING

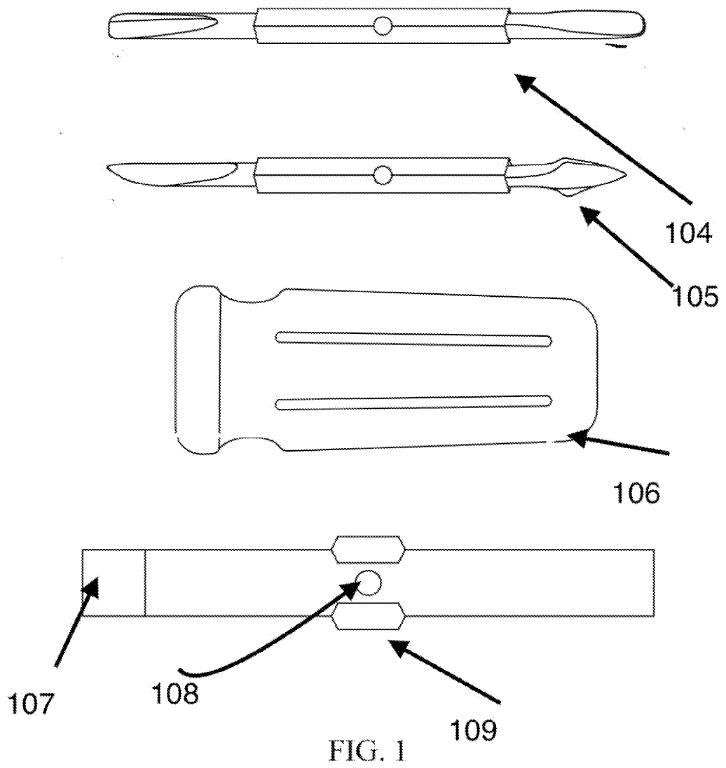

FIG. 1, The present invention requires very minimum time to assemble. Novel combination device is composed of a handle, metal cylindrical hollow shaft and two metal double ended bits. The handle 106 is composed of hollow tunnel with two rectangular grooves or female receptacles. The hollow shaft 107 contains two males attachments 109 in the center of shaft on either side with small metal ball 108 in between two male attachments. Two double ended bits 104 and 105.

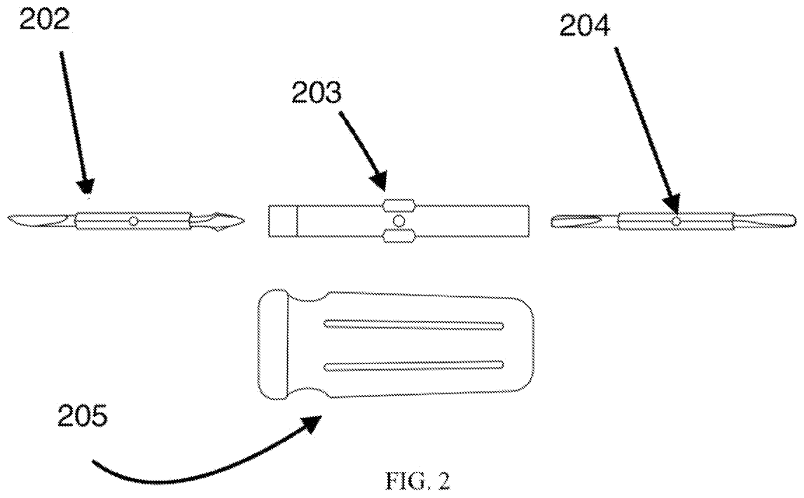

FIG. 2. The explosive view of the invention; illustrates one way the device can be assembled. 202 is a double end bit which can be easily flipped to utilize the opposite bit, 203 is the hollow cylinder which serves like the connector for all the other tools. 204 is another double end bit. The hollow shaft or cylinder is designed with a double male attachment on the side and a metal release ball in the center. A double ended bit is inserted into each side of the shaft, and it held together by interlocking of external hexagon shape of bit with internal hexagonal shape on inside of hollow shaft.

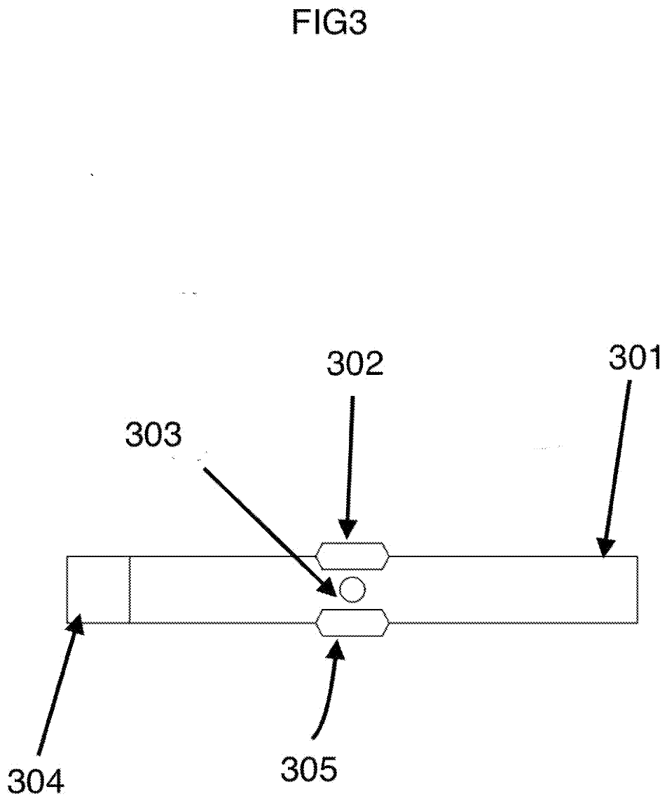

FIG. 3. This is an illustration of a component of the invention. The hollow shaft or cylinder is the connecting piece to all the other component of the invention, the shaft is designed with one end 304 slightly smaller diameter then the other end 301. The shaft is designed with two male attachments 302 and 305 with a metal release ball in the middle. Additionally, a hollow opening of shaft has internal hexagonal shape.

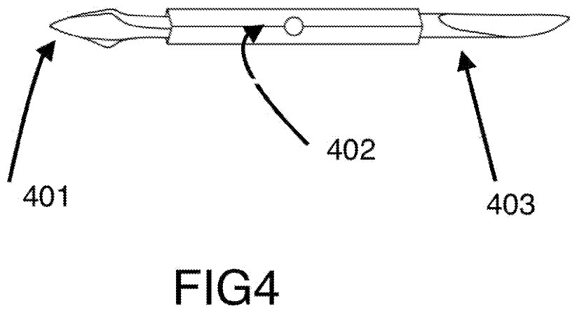

FIG. 4. This is an illustration of a component of the invention. Each double ended bit is external hexagonal shaped each double ended bit contains two different straight elevators on opposite sides. The depicted pictures are 401 #63 spade elevator on one end and 403 #1 Heidbrink straight root tip pick on the other.

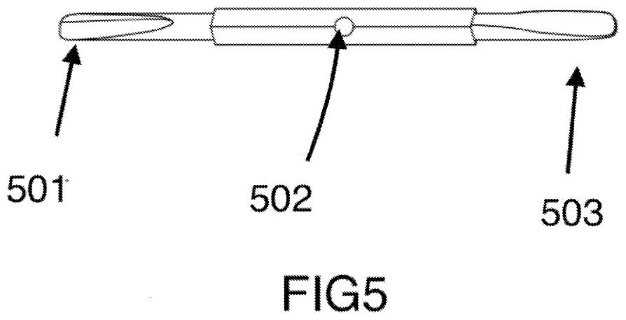

FIG. 5. This is an illustration of a component of the invention. Each double ended bit is external hexagonal shaped each double ended bit contains two different straight elevators on opposite sides. The depicted pictures are one double ended bit will contain 501 301 Apexo straight elevator on one end and 503 343 straight elevator with 4 mm tip on the opposite end. The bit is designed with a metal ball release in the center.

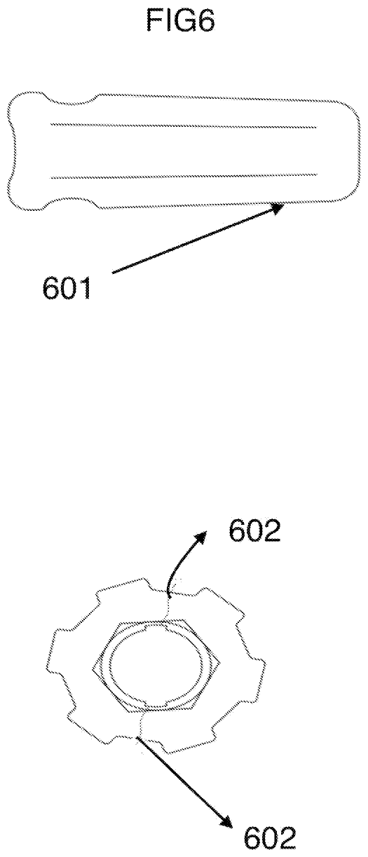

FIG. 6. This is an illustration of a component of the invention. The handle of the device is an important piece to the invention. The handle 601 is composed of hollow tunnel with two rectangular grooves or female receptacles 602.

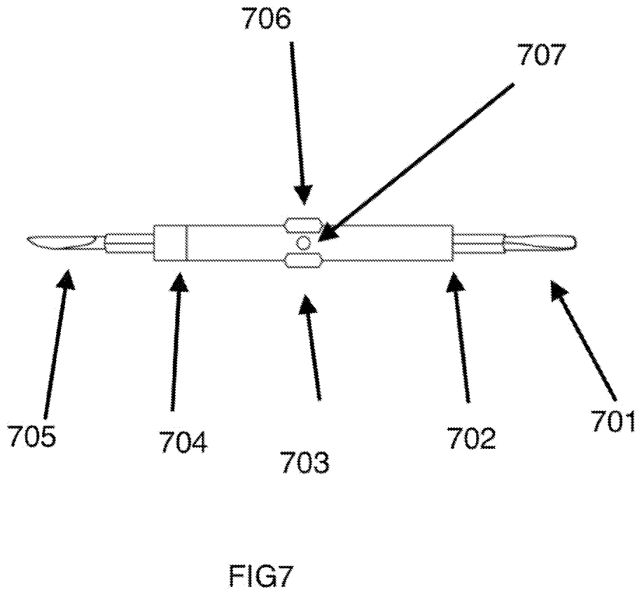

FIG. 7. This is an illustration of a component of the invention. The hollow shaft contains two male attachments 703 and 706 on either side of the shaft with small metal ball 707 in the center. One end 704 of shaft has slightly smaller diameter then the other end 702. Two double ended bits 705 and 701 are attached to the hollow shaft or cylinder.

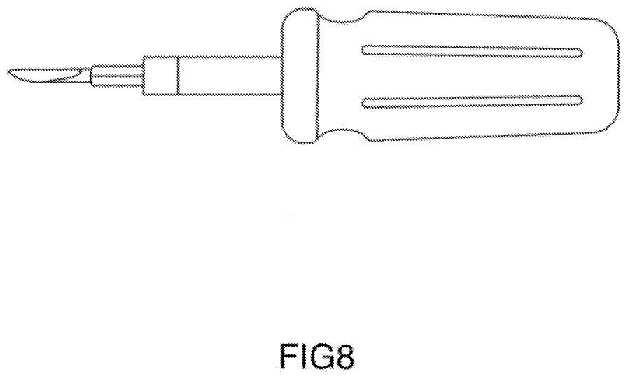

FIG. 8. This drawing is an illustration of a fully assembled version of the invention.

It should be noted; the preceding description is merely given as an illustration; and is not limiting of the invention. There are possibilities of various modifications; without departing from the spirit of the invention.

1. A novel combination device for tooth extraction with Snap-On handle and interchangeable or retractable working ends.

2. The invention is novel combination of a four dental tool connector with a handle.

3. The present invention is light weight, compact and easy to assemble and disassemble the invention.

4. The invention includes straight elevators, spade elevator and root tip pick combination.

5. The invention is designed so there is more space available for other necessary equipment (4 in 1 device take less space).

6. The invention reduces the need for constant sterilization because less tools are used.

7. The invention eliminates the lengthy search for instruments (since 4 in one device).

8. The invention reduces switching instruments (since 4 in one device, just flip and insert).

9. The invention create less procedural time (no need to look for instruments, b/c no need to switch or search).
